(19) United States
(12) Patent Application Publication
(10) Pub. No.: US 2011/0205942 A1
(43) Pub. Date: Aug. 25, 2011

(54) COMBINING CCE's FOR POWER BALANCING

(75) Inventors: Lars Erik Lindh, Helsingfors (FI); Jari Mattila, Helsinki (FI); Frank Frederiksen, Klarup (DK)

(73) Assignee: NOKIA CORPORATION, Espoo (FI)

(21) Appl. No.: 12/866,028

(22) PCT Filed: Feb. 3, 2009
(86) PCT No.: PCT/IB09/00187

§ 371 Date: Dec. 2, 2010

Related U.S. Application Data
(60) Provisional application No. 61/006,864, filed on Feb. 4, 2008.

(51) Int. Cl. H04L 5/14

(52) U.S. Cl. 370/294

(57) ABSTRACT

A method of reordering and pairing the set of elements, such as Control Channel Elements (CCEs), coming out of an interleaver for a channel, such as the Physical Downlink Control Channel (PDCCH), in such a way that power balancing provides almost equal impact on all Orthogonal Frequency Division Multiplexing (OFDM) symbols reserved for the control channel, while also taking the suggestions for the power balancing into account is provided. Corresponding apparatuses and computer programs are also provided.

### BACKGROUND

1. Field

Certain embodiments of the present invention provide a method of reordering and pairing the set of Control Channel Elements (CCEs) coming out of the interleaver for the Physical Downlink Control Channel (PDCCH) in such a way that power balancing provides almost equal impact on all Orthogonal Frequency Division Multiplexing (OFDM) symbols reserved for the control channel, while also taking the suggestions for the power balancing into account.

2. Description of the Related Art

Currently, the issues addressed by various embodiments of the present invention have not been addressed in 3GPP. Thus, there does not appear to be any directly related art.

### SUMMARY

One embodiment of the present invention is an apparatus. The apparatus includes a processor configured to sort a set of elements coming from an interleaver for a channel in a way that gives the minimum penalty in terms of power balancing. The processor is configured to determine which elements should be combined into pairs. The processor is configured to combine the pairs as determined.

Another embodiment of the present invention is a method. The method includes receiving a set of elements coming out of an interleaver for a channel. The method also includes sorting the elements coming from the interleaver in a way that gives the minimum penalty in terms of power balancing. The method further includes determining which elements should be combined into pairs. The method additionally includes combining the pairs as determined.

A further embodiment of the present invention is a computer program embodied on a computer readable medium, and configured to cause a hardware device to execute a method. The method includes receiving a set of elements coming out of an interleaver for a channel. The method also includes sorting the elements coming from the interleaver in a way that gives the minimum penalty in terms of power balancing. The method further includes determining which elements should be combined into pairs. The method additionally includes combining the pairs as determined.

Another embodiment of the present invention is an apparatus. The apparatus includes receiving means for receiving a set of elements coming out of an interleaver for a channel. The apparatus also includes sorting means for sorting the elements coming from the interleaver in a way that gives the minimum penalty in terms of power balancing. The apparatus further includes determining means for determining which elements should be combined into pairs. The apparatus additionally includes combining means for combining the pairs as determined.

### BRIEF DESCRIPTION OF THE DRAWINGS

For proper understanding of the invention, reference should be made to the accompanying drawings, wherein:

FIG. 1 illustrates one approach for creating a set of mini-CCEs and the corresponding suggested numbering scheme;

FIG. 2 illustrates the combination of control channel elements to create aggregated control channel candidates according to a tree structure;

FIG. 3 illustrates the clustering principle, where good channel condition users are shifted to one side of the decoding tree;

FIG. 4 illustrates a method according to an embodiment of the present invention; and

FIG. 5 illustrates an apparatus according to an embodiment of the present invention.

### DETAILED DESCRIPTION

As discussed above, certain embodiments of the present invention are related to the concept creation of LTE of 3GPP. More specifically, embodiments can be related to the H-ARQ design for the downlink PHICH.

Yet more particularly, the present invention may relate to the control channel structure in the context of the Frequency Division Duplex (FDD) mode of 3GPP, but would easily be mapped to Time Division Duplex (TDD) mode as well, since the concept of creating control channels is based on the same thinking for both types of operational mode.

Related to the general control channel structure, it is such that there will be a division between control and data, such that these are using time domain multiplexing (meaning that a number of Orthogonal Frequency Division Multiplexed (OFDM) symbols in each Transmission Time Interval (TTI) will carry the control channels for a number of the User Equipment (UE) (Physical Downlink Control Channel (PDCCH), and a set of OFDM symbols will carry the shared channel for a number of users (Physical Downlink Shared Channel (PDSCH)).

The general understanding if that the physical resources for the control part will be divided into a set of elements, which are all based on mini-Control Channel Elements (mini-CCEs), which are the smallest building block for the control channel. Each mini-CCE is constructed of four neighboring resource elements (RE—also known as subcarrier symbols, which each again will potentially carry two bits that are Quaternary Phase Shift Key (QPSK) modulated). These channels for the control part can be:
PCFICH: Physical control format indicator channel. Indication of which amount of OFDM symbols are used for the control channel. Possible values: 1, 2, and 3. This is an option for system bandwidths larger than 1.4 MHz. For the 1.4 MHz case, the possible values can be 2, 3, and 4. Can take up a total of four mini-CCE on the first OFDM symbol of each TTI.
PHICH: Physical H-ARQ indication channel. Can be used for providing H-ARQ control information for previous uplink transmissions. Can use 3 mini-CCEs for each PHICH group. The number of PHICH groups can be configurable through PBCH (Primary broadcast channel).
CCE resources: The remaining set of physical resources. These will be divided into a number of mini-CCEs, which will be discussed below.

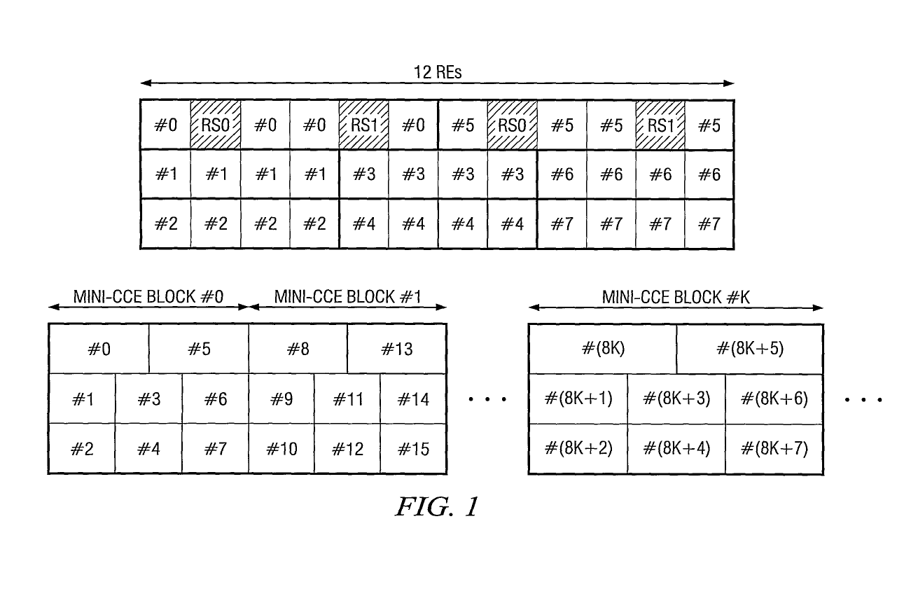

An example structure of the creation and allocation of the mini-CCEs is shown in FIG. 1, where it is seen that each mini-CCE can be constructed of these four neighboring resource elements (upper part), and for the shown case there are three OFDM symbols allocated for control channel information. The mini-CCEs can be interleaved and combined in blocks to create a control channel element (CCE), which in some cases will be constructed of 9 mini-CCEs, at least for 5 MHz system bandwidth and below. For higher system bandwidths, a larger number of mini-CCE can be used for creating a CCE (12 for 10 MHz, and 15 for 20 MHz). Alternatively, for higher system bandwidths, the number of mini-CCEs can also be 9. FIG. 1, thus, provides an illustration of one approach for creating a set of mini-CCEs and the corresponding suggested numbering scheme.

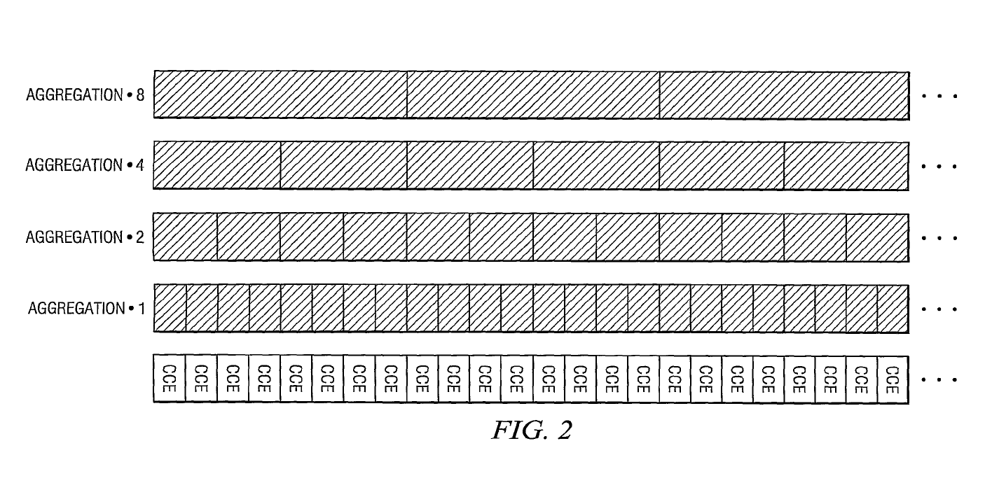

A second part that may be useful to understand the invention here is the concept of control channel aggregation. Here the principle is that it should be possible to combine (or aggregate) the physical resources from multiple CCEs to provide better coverage (more physical resources for the same PDCCH payload will give better channel coding and thus better coverage). One such example of control channel aggregation is shown in FIG. 2. FIG. 2 provides an illustration of the combination of control channel elements to create aggregated control channel candidates according to a tree structure.

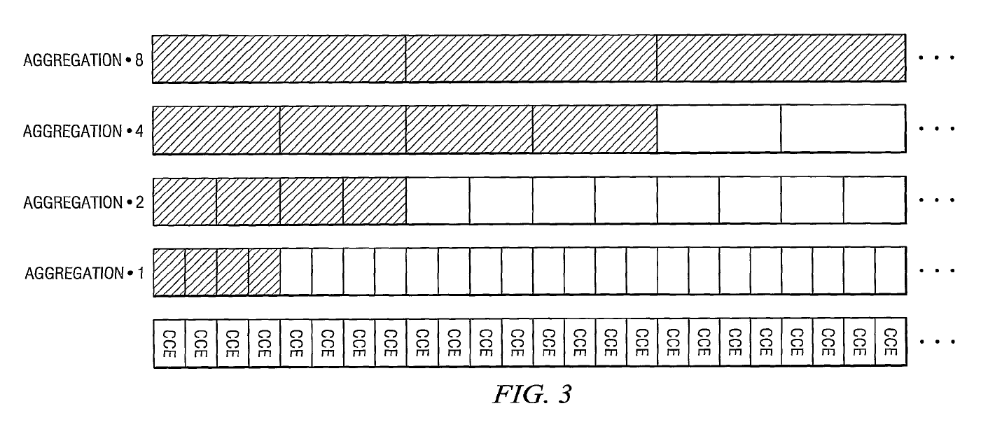

Additionally, the decoding complexity can be reduced by only allowing certain parts of the CCEs and different parts of the aggregations to be used for actual allocations. One such principle is illustrated in FIG. 3, where it is seen that only part of the decoding ‘tree’ is eligible for decoding. This is only an illustration of the principles of the decoding restrictions that are suggested in the present application, and the borders for different aggregation levels might be changed in a particular implementation.

FIG. 3, accordingly, provides an example of the clustering principle. In FIG. 3, good channel condition users are shifted to one side of the decoding tree, thus reducing the total amount of decoding attempts in the UE. It should be kept in mind that this is just one example, and is not essential to follow this example in every embodiment of the invention.

In order to provide a flexible and potentially optimum handling of the allocated users, one may use power balancing between the allocated users (that is, reducing the transmission power for good condition users, and transfer this power to users in poor conditions).

It may be useful to implement a method of reordering and pairing the set of CCEs coming out of the interleaver for the PDCCH in such a way that power balancing provides almost equal impact on all OFDM symbols reserved for the control channel, while also taking the suggestions for the power balancing into account.

Currently, considering the interleaver structures otherwise suggested for LTE, there may not be a good and fair division/balance between the number of mini-CCEs assigned to the different OFDM symbols for the control channels. To illustrate, some example calculations have been performed:

There are altogether 200 mini-CCEs in the three OFDM symbols (50+75+75) at BW=5 MHz.

PCFICH=[0, 48, 101, 149] (from the 1st OFDM symbol)

PHICH=[5, 72, 141] (from the 1st OFDM symbol)

PDCCH=[1×43 double] [1×75 double] [1×75 double] (=193=75+75+43)

Using 9 mini-CCEs per CCE, there are 21 full CCEs (21*9=189), so there remain 4 unused mini-CCEs.

We have randomized the mini-CCE indexes {1, 1, 1, 1, 1, 1, 1, 1, 1, 2, 2, 2, 2, 2, 2, 2, 2, 2, . . . , 21, 21, 21, 21, 21, 21, 21, 21, 21} with the Subblock interleaver (length=193) and then allocated them to RBs with time-first mapping shown in FIG. 1.

Statistics of the number of mini-CCEs per OFDM symbols S1, S2, S3 is given below.

| CCE | S1 | S2 | S3 |
|---|---|---|---|
| 1 | 2 | 5 | 2 |
| 2 | 1 | 2 | 6 |
| 3 | 3 | 3 | 3 |
| 4 | 1 | 2 | 6 |
| 5 | 3 | 3 | 3 |
| 6 | 3 | 3 | 3 |
| 7 | 2 | 5 | 2 |
| 8 | 4 | 2 | 3 |
| 9 | 2 | 4 | 3 |
| 10 | 2 | 3 | 4 |
| 11 | 0 | 5 | 4 |
| 12 | 2 | 5 | 2 |
| 13 | 0 | 5 | 4 |
| 14 | 2 | 4 | 3 |
| 15 | 1 | 2 | 6 |
| 16 | 3 | 2 | 4 |
| 17 | 3 | 1 | 5 |
| 18 | 1 | 6 | 2 |
| 19 | 3 | 3 | 3 |
| 20 | 3 | 5 | 1 |
| 21 | 2 | 5 | 2 |
| Sum = | 43 | 75 | 71 |

From this it is seen that some CCEs may not have any mini-CCEs in the first OFDM symbol (#11 ad 13), while others have an over-representation of mini-CCEs in the first OFDM symbol (#8 in this example). This can cause a problem in terms of utilizing the power balancing mechanisms (for instance lowering power for CCE number 11 will not free any power for OFDM symbol number 1). Certain embodiments of the present invention can handle/solve this problem, although there is no conventional solution to the problem.

In certain embodiments, the present invention provides a method of reordering and pairing the set of CCEs coming out of the interleaver for the PDCCH in such a way that power balancing provides almost equal impact on all OFDM symbols reserved for the control channel, while also taking the suggestions for the power balancing into account.

The scheme can base its numbering scheme on the following principles.

First, one can sort the CCEs coming from the interleaver in a way that gives the minimum penalty in terms of power balancing. One such approach for this could be to assign a weight for each CCE that reflects the distance between the amount of mini-CCEs in each OFDM symbol to the expected average amount of mini-CCE in each of these. The algorithm for calculating this could be:

W_{—}i=sum((x_{—}i,k−y_{—}i)̂2),

where W_i is the weight for the i'th CCE, x_i,k it the number of mini-CCE for the i'th CCE and k'th OFDM symbol, and y_i is the average number of mini-CCE for each k OFDM symbol. In the example in section 2, y_i will take the following values: {43/21, 75/21, 71/21}. One of ordinary skill in the art would appreciate that other metrics for calculating the weight could of course be envisioned, and that this example algorithm focuses on minimizing the squared error or distance.

When this ordering has been performed, one has the sequence of the CCEs that are required for the lower layer of the aggregation tree, and one can then calculate the entries for the second level of aggregation.

This leads us to a second part of the example algorithm. When determining which CCEs should be combined into pairs, one can look for the mini-CCE that have the worst weights and try to combine these, such that their combined weight gets low. The approach for this could be simple trial and error, but from an implementation point of view this may not be optimal, as the Node B (sometimes referred to as a base station or access point) and the User Equipment (UE) (sometimes referred to as a terminal or mobile station, though there is no requirement that the UE be mobile) might come to different preferred pairs and end up not having a common agreement on which CCEs are paired on the second aggregation level.

When it is stated that the weight “gets low” the measure of “low” can be “low” relative to the other weights under consideration. For example, something with a low weight would not provide a significant contribution.

As an alternative, the following algorithm may be used.

First, one can sort the CCEs in ascending order using the number of mini-CCE in the first OFDM symbol. If some CCE have the same number of mini-CCE, they can be sorted in ascending order according to the number of mini-CCE in the second OFDM symbol, and so on.

Following this, the CCEs can be paired from the outer elements of this sorted set, meaning that one can combine the CCEs with the fewest and most mini-CCE in the first OFDM symbol for the first aggregated CCE (outside the region for the single CCE, which were found in the first step). Using this approach, one can provide better power balancing for the aggregated CCEs.

A potential third step of the algorithm could be to repeat the exercise for aggregation levels 4 and 8, but the main gain should be may be able to be achieved simply from the two lower aggregation levels, without repeating the algorithm at the aggregation levels 4 and 8.

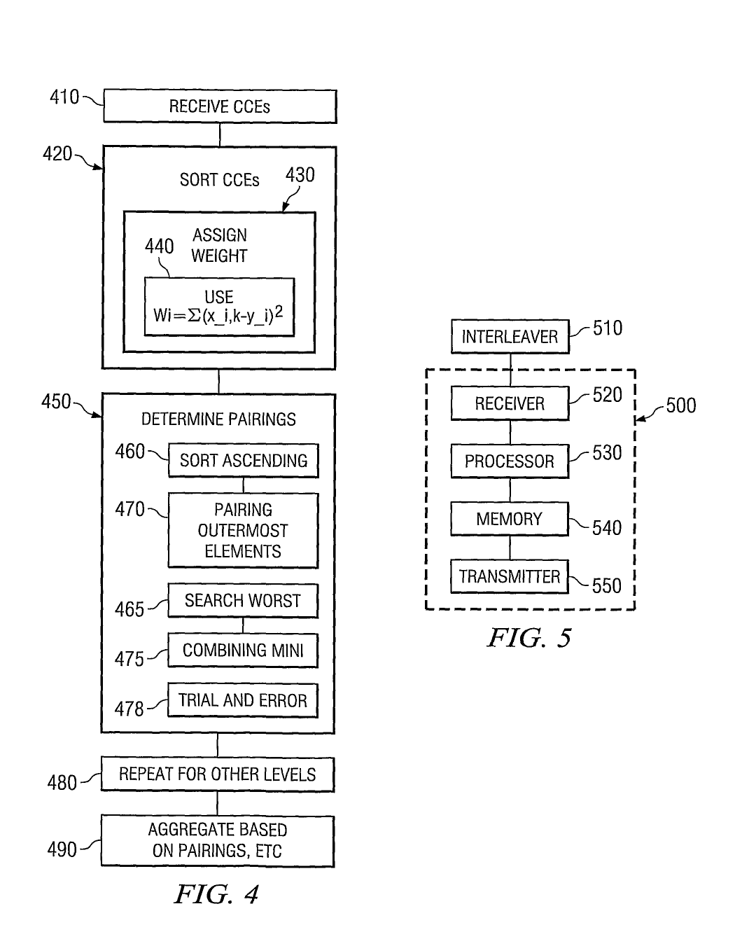

FIG. 4 illustrates a method for reordering and pairing a set of control channel elements (CCEs) coming out of an interleaver for a Physical Downlink Control Channel (PDCCH). As illustrated, the method can include receiving 410 a set of control channel elements (CCEs) coming out of an interleaver for a Physical Downlink Control Channel (PDCCH). The method can also include sorting 420 the CCEs coming from the interleaver in a way that gives the minimum penalty in terms of power balancing. The method can further include determining 430 which CCEs should be combined into pairs. The method can additionally include combining 490 the pairs as determined.

The sorting 420 the CCEs can include assigning 430 a weight for each CCE that reflects the distance between the amount of mini-CCEs in each OFDM symbol to the expected average amount of mini-CCE in each of the CCEs. The sorting 420 the CCEs can include using 440 the algorithm

W_{—}i=sum((x_{—}i,k−y_{—}i)̂2),

where W_i is the weight for the i'th CCE, x_i,k it the number of mini-CCE for the i'th CCE and k'th OFDM symbol, and y_i is the average number of mini-CCE for each k OFDM symbol.

The determining 450 which CCEs should be combined into pairs can include looking 465 for the mini-CCE that have the worst weights and trying 475 to combine these, such that their combined weight gets low.

The determining 450 which CCEs should be combined into pairs can include a process 478 of trial and error.

The determining 450 which CCEs should be combined into pairs can include sorting 460 the CCEs in ascending order using the number of mini-CCE in the first OFDM symbol, wherein if some CCE have the same number of mini-CCE, they are sorted in ascending order according to the number of mini-CCE in the second OFDM symbol, and so on, and pairing 470 the CCEs from the outer elements of this sorted set.

The method can further including repeating 480 an aggregation accomplished by the sorting and the determining, for aggregation levels four and eight.

The method can be implemented using, for example, a computer program embodied on a computer readable medium, such as a computer-readable storage medium, and configured to cause a hardware device to execute the method for reordering and pairing the set of control channel elements (CCEs) coming out of an interleaver for a Physical Downlink Control Channel (PDCCH) when the computer program is run on the hardware device.

As illustrated in FIG. 5, the present invention can provide, for example, an apparatus 500 for reordering and pairing the set of control channel elements (CCEs) coming out of an interleaver 510 for a Physical Downlink Control Channel (PDCCH). The apparatus 500 can include a receiver 520 configured to receive the set of CCEs. The apparatus 500 can also include a processor 530 configured to sort the CCEs coming from the Interleaver in a way that gives the minimum penalty in terms of power balancing. The processor 530 can also be configured to determine which CCEs should be combined into pairs. The processor 530 can further be configured to combine the pairs as determined.

The processor 530 can be configured to sort the CCEs by assigning a weight for each CCE that reflects the distance between the amount of mini-CCEs in each OFDM symbol to the expected average amount of mini-CCE in each of the CCEs.

The processor 530 can be configured to sort the CCEs using the algorithm

W_{—}i=sum((x_{—}i,k−y_{—}i)̂2),

where W_i is the weight for the i'th CCE, x_i,k it the number of mini-CCE for the i'th CCE and k'th OFDM symbol, and y_i is the average number of mini-CCE for each k OFDM symbol.

The processor 530 can be configured to determine which CCEs should be combined into pairs by looking for the mini-CCE that have the worst weights and by trying to combine these, such that their combined weight gets low.

The processor 530 can be configured to determine which CCEs should be combined into pairs by a process of trial and error.

The processor 530 can be configured to determine which CCEs should be combined into pairs by sorting the CCEs in ascending order using the number of mini-CCE in the first OFDM symbol, wherein if some CCE have the same number of mini-CCE, they are sorted in ascending order according to the number of mini-CCE in the second OFDM symbol, and so on, and by pairing the CCEs from the outer elements of this sorted set.

The processor 530 can be further configured to repeat an aggregation accomplished by sorting and determination for aggregation levels four and eight.

The processor 530 can be, for example, a general purpose computer or Application Specific Integrated Circuit (ASIC).

A memory 540 (which may be useful for storing data such as CCEs and computer programs) and a transmitter 550 (which may be useful for externally communicating data) can also be included in the apparatus 500. Of course, it is not required that the memory 540, processor 530, transmitter 550, and receiver 520 be separate physical elements, and consequently all of these components may be implemented as a single chip. The interleaver 510 may be on the same chip, or may be on a separate chip or device.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1-28. (canceled)

29. An apparatus, comprising:
a processor configured to:
sort a set of elements coming from an interleaver for a channel in a way that gives the minimum penalty in terms of power balancing;
determine the elements to be combined into pairs; and
combine the elements into the pairs as determined.

30. The apparatus according to claim 29, wherein the elements comprise control channel elements.

31. The apparatus according to claim 29, wherein the channel is a physical downlink control channel.

32. The apparatus according to claim 29, wherein the processor is configured to sort the set of elements by assigning a weight for each element that reflects a distance between the amount of mini-elements in each orthogonal frequency division multiplexing symbol to the expected average amount of mini-elements in each of the elements.

33. The apparatus according to claim 29, wherein the processor is configured to sort the set of elements using an algorithm
W_{—}i=sum((x_{—}i,k−y_{—}i)̂2),
wherein W_i is the weight for the i'th element, x_i,k is the number of mini-elements for the i'th element and k'th orthogonal frequency division multiplexing symbol, and y_i is the average number of mini-elements for each k'th orthogonal frequency division multiplexing symbol.

34. The apparatus according to claim 29, wherein the processor is configured to determine the elements to be combined into pairs by determining the mini-elements that have the worst weights and by trying to combine these, such that their combined weight is low relative to the other weights.

35. The apparatus according to claim 29, wherein the processor is configured to determine which elements should be combined into pairs by a process of trial and error.

36. The apparatus according to claim 29, wherein the processor is configured to determine the elements to be combined into pairs by sorting the elements in ascending order using the number of mini-elements in an orthogonal frequency division multiplex symbol, wherein when some elements have the same number of mini-elements, they are sorted in ascending order according to the number of mini-elements in the next orthogonal frequency division multiplex symbol, and so on, and by pairing the elements from the outer elements of this sorted set.

37. The apparatus according to claim 29, wherein the processor is further configured to repeat an aggregation accomplished by sorting and determination for higher aggregation levels.

38. A method, comprising:
receiving a set of elements coming out of an interleaver for a channel;
sorting the elements coming from the interleaver in a way that gives the minimum penalty in terms of power balancing;
determining the elements to be combined into pairs; and
combining the elements into the pairs as determined.

39. The method according to claim 38, wherein the elements comprise control channel elements.

40. The method according to claim 38, wherein the channel is a physical downlink control channel.

41. The method according to claim 38, wherein the sorting the elements comprises assigning a weight for each element that reflects a distance between the amount of mini-elements in each orthogonal frequency division multiplexing symbol to the expected average amount of mini-elements in each of the elements.

42. The method according to claim 38, wherein the sorting the elements comprises using an algorithm
W_{—}i=sum((x_{—}i,k−y_{—}i)̂2),
where W_i is the weight for the i'th element, x_i,k it the number of mini-elements for the i'th element and k'th orthogonal frequency division multiplexing symbol, and y_i is the average number of mini-elements for each k'th orthogonal frequency division multiplexing symbol.

43. The method according to claim 38, wherein the determining the elements to be combined into pairs comprises determining the mini-elements that have the worst weights and trying to combine these, such that their combined weight is low relative to the other weights.

44. The method according to claim 38, wherein the determining which elements should be combined into pairs comprises a process of trial and error.

45. The method according to claim 38, wherein the determining which elements should be combined into pairs comprises sorting the elements in ascending order using the number of mini-elements in an orthogonal frequency division multiplexing symbol, wherein when some elements have the same number of mini-elements, they are sorted in ascending order according to the number of mini-elements in the next orthogonal frequency division multiplexing symbol, and so on, and pairing the elements from the outer elements of this sorted set.

46. The method according to claim 38, further comprising:
repeating an aggregation accomplished by the sorting and the determining, for higher aggregation levels.

47. A computer program product comprising a computer-readable medium bearing computer program code embodied therein for use with a computer, the computer program code comprising:
code for sorting a set of elements coming from an interleaver for a channel in a way that gives the minimum penalty in terms of power balancing;
code for determining the elements to be combined into pairs; and
code for combining the elements into the pairs as determined.

48. A computer program product according to claim 47, wherein the code for sorting the set of elements comprises code for assigning a weight for each element that reflects a distance between the amount of mini-elements in each orthogonal frequency division multiplexing symbol to the expected average amount of mini-elements in each of the elements.
